(19) United States
(12) Patent Application Publication
(10) Pub. No.: US 2012/0243475 A1
(43) Pub. Date: Sep. 27, 2012

(54) Method of Converging a Plurality of Communication Standards and Related Communication Device

(76) Inventors: Chia-Wei Yen, Hsinchu County (TW); Jian-Li Mao, Hsinchu County (TW)

(21) Appl. No.: 13/426,617

(22) Filed: Mar. 22, 2012

Related U.S. Application Data
(60) Provisional application No. 61/467,394, filed on Mar. 25, 2011.

(51) Int. Cl. H04W 4/00

(52) U.S. Cl. 370/328

(57) ABSTRACT

A method of converging a plurality of communication standards is disclosed. The method comprises establishing a unified medium access control (MAC) layer comprising a unified physical (PHY) interface; and arranging the unified MAC layer between an upper layer and a plurality of PHY layers of the plurality of communication standards.

### CROSS REFERENCE TO RELATED APPLICATIONS

This application claims the benefit of U.S. Provisional Application No. 61/467,394, filed on Mar. 25, 2011 and entitled “Define an Unified MAC Layer with Unified PHY Interface”, the contents of which are incorporated herein in their entirety.

### BACKGROUND OF THE INVENTION

1. Field of the Invention

The present invention relates to a method used in a communication system and related communication device, and more particularly, to a method of arranging a unified medium access control (MAC) layer comprising a unified physical (PHY) interface and related communication device.

2. Description of the Prior Art

With rapidly growing of user's needs for accessing digital contents everywhere, various communication standards have been developed for transmission of the digital contents. These communication standards maybe developed for different environments, different transmission speeds and/or different user requirements. Further, organizations and industries are now devoting to develop improved version of the existing communication standards as well as completely new communication standards for satisfying the user's needs.

However, even though these communication standards have been developed to satisfy the user's needs, it may be difficult for a user to use a communication device conforming to these communication standards due to various system parameter settings for these communication standards. Further, if each of these communication standards is realized by a specific module of the communication device, power consumption is high due to using separate modules for realizing these communication standards. Besides, manufacturing such the communication device is inefficient in both cost and size, since part of functions of these communication standards are the same and should be converged.

Therefore, a method for efficiently converging these various communication standards is needed.

### SUMMARY OF THE INVENTION

The present invention therefore provides a method and related communication device for arranging a unified medium access control (MAC) layer comprising a unified physical (PHY) interface to solve the abovementioned problems.

A method of converging a plurality of communication standards is disclosed. The method comprises establishing a unified medium access control (MAC) layer comprising a unified physical (PHY) interface; and arranging the unified MAC layer between an upper layer and a plurality of PHY layers of the plurality of communication standards.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary communication system according to the present invention.

FIG. 2 is a schematic diagram of an exemplary communication device according to the present invention.

FIG. 3 is a flowchart of an exemplary process according to the present invention.

FIG. 4 is a schematic diagram of an exemplary protocol stack according to the present invention.

### DETAILED DESCRIPTION

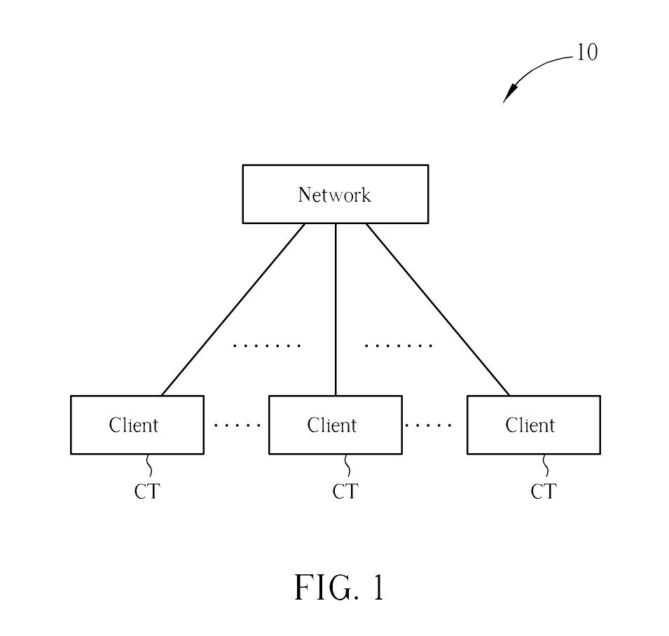

Please refer to FIG. 1, which is a schematic diagram of a communication system 10 according to an example of the present invention. The communication system 10 is briefly composed of a network and a plurality of clients CT. In FIG. 1, the network and the clients CT are simply utilized for illustrating the structure of the communication system 10. Practically, the network can be referred as to any network equipment such as a server, a gateway, a router or a bridge. The clients CT can be mobile phones, laptops, tablet computers, electronic books, and portable computer systems. Further, a client CT may communicate with the network or another client CT according to a communication standard such as the IEEE 802.3 standard, the IEEE 802.11 standard, the IEEE 1901 standard or the Multimedia over Coax Alliance (MoCA) standard, and is not limited herein.

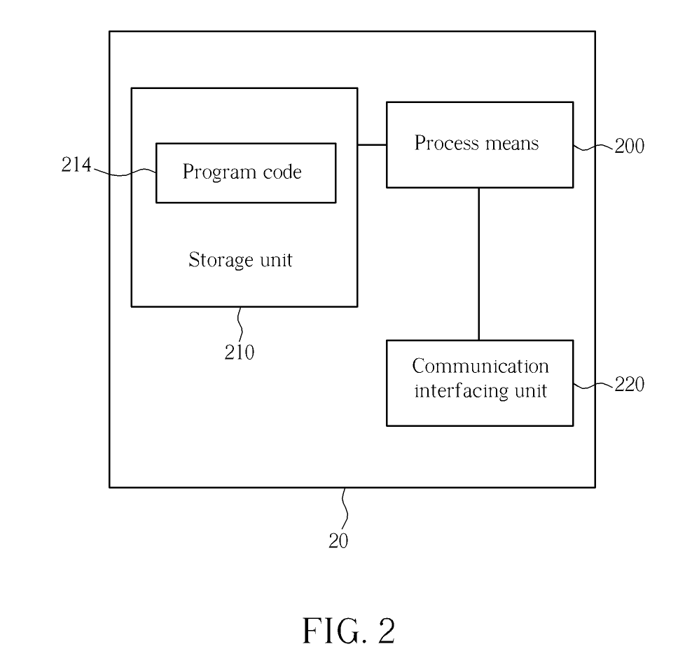

Please refer to FIG. 2, which is a schematic diagram of a communication device 20 according to an example of the present invention. The communication device 20 can be a client CT or the network shown in FIG. 1, but is not limited herein. The communication device 20 may include a processor 200 such as a microprocessor or an Application Specific Integrated Circuit (ASIC), a storage unit 210 and a communication interfacing unit 220. The storage unit 210 may be any data storage device that can store a program code 214, accessed by the processor 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a transceiver and can exchange signals with a client CT or the network according to processing results of the processor 200.

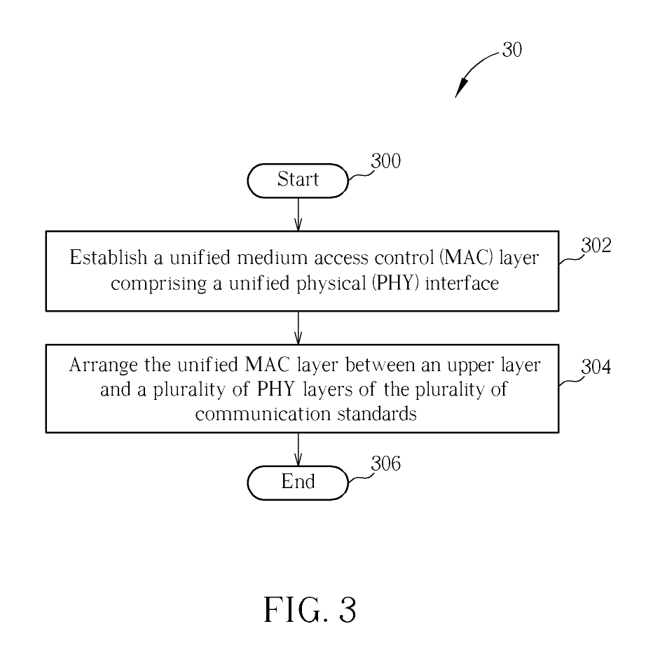

Please refer to FIG. 3, which is a flowchart of a process 30 according to an example of the present invention. The process 30 is utilized in a client CT or the network shown in FIG. 1, for converging a plurality of communication standards. The process 30 may be compiled into the program code 214 and includes the following steps:

Step 300: Start.

Step 302: Establish a unified medium access control (MAC) layer comprising a unified physical (PHY) interface.

Step 304: Arrange the unified MAC layer between an upper layer and a plurality of PHY layers of the plurality of communication standards.

Step 306: End.

According to the process 30, the unified MAC layer comprising the unified PHY interface is established, and is arranged between the upper layer and the plurality of PHY layers of the plurality of communication standards. In other words, the unified MAC layer replaces MAC layers corresponding to the plurality of PHY layers, and is used for all the plurality of PHY layers. Therefore, not only redundant codes and redundant circuits can be avoided, but the client CT and the network can be set up more easily due to a single MAC layer. In comparison, a corresponding MAC layer is required for each PHY layer in the prior art. Not only the redundant codes and the redundant circuits are required, but it is inconvenient to setup the client CT and the network due to various parameters related to the corresponding MAC layers.

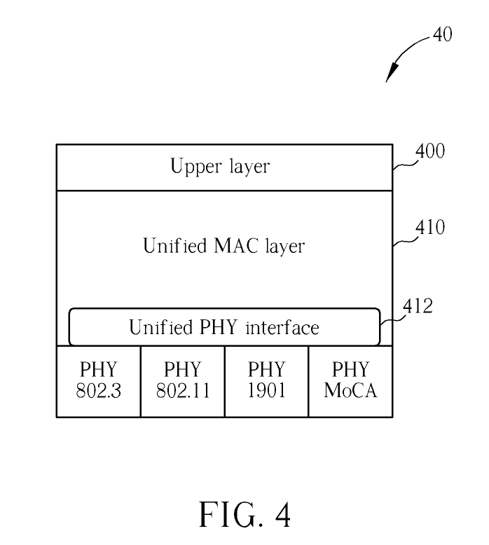

Please note that, detail of the unified MAC layer can be defined according to the communication device 20 in which the unified MAC layer is installed and the plurality of PHY layers it is connected with, and is not limited, as long as signals and signalings between the upper layer and the plurality of PHY layers can be properly processed. For example, please refer to FIG. 4, which is a schematic diagram of a protocol stack 40 according to an example of the present invention. The protocol stack 40 includes an upper layer 400, a unified MAC layer 410, a unified PHY interface 412 and a plurality of PHY layers including PHY 802.3, PHY 802.11, PHY 1901 and PHY MoCA conforming to the IEEE 802.3 standard, the IEEE 802.11 standard, the IEEE 1901 standard or the MoCA standard, respectively. The upper layer 400 can be a network layer, a transport layer, an application layer or any layer responsible for processing signals received from the unified MAC layer 410 and signals to be transmitted via the unified MAC layer 410. Besides, the unified PHY interface 412 is an interface between the unified MAC layer 410 and the plurality of PHY layers, and is used for processing signalings between the unified MAC layer 410 and the plurality of PHY layers. On the other hand, the unified MAC layer 410 can be modified from a MAC layer of an existing standard, or can be newly developed (e.g. according to the plurality of PHY layers it is connected with). The existing standard can be the IEEE 802.3 standard, the IEEE 802.11 standard, the IEEE 1901 standard or the MoCA standard, and is not limited herein. In short, detail realization of the protocol stack 40 depends on a type of the communication device 20 in which the protocol stack 40 is installed, and those skilled in the art should readily make modifications or alterations accordingly.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a unified MAC layer comprising a unified PHY interface, for converging a plurality of communication standards, to simplify a protocol stack in which the unified MAC layer and the unified PHY interface are located. Therefore, not only realization of the protocol stack can be simplified, but a client and a network in which the protocol stack is installed can be set up easily. Thus, the present invention helps both users and manufacturers of the client and the network in terms of cost and convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of converging a plurality of communication standards, the method comprising:
establishing a unified medium access control (MAC) layer comprising a unified physical (PHY) interface; and
arranging the unified MAC layer between an upper layer and a plurality of PHY layers of the plurality of communication standards.

2. The method of claim 1, wherein the unified MAC layer is used for processing signalings between the upper layer and the plurality of PHY layers.

3. The method of claim 1, wherein the unified MAC layer is modified from a MAC layer of an existing standard, or is a newly defined MAC layer.

4. The method of claim 3, wherein the existing standard is the IEEE 802.3 standard, the IEEE 802.11 standard, the IEEE 1901 standard or the Multimedia over Coax Alliance (MoCA) standard.

5. The method of claim 1, wherein the unified PHY interface is an interface between the unified MAC layer and the plurality of PHY layers.

6. The method of claim 5, wherein the unified PHY interface is used for processing signalings between the unified MAC layer and the plurality of PHY layers.

7. The method of claim 1, wherein the plurality of communication standards comprise at least one of the IEEE 802.3 standard, the IEEE 802.11 standard, the IEEE 1901 standard and the MoCA standard.
